(19) United States
(12) Patent Application Publication
(10) Pub. No.: US 2015/0001115 A1
(43) Pub. Date: Jan. 1, 2015

(54) HEAT-SENSITIVE TRANSFER RECORDING MEDIUM, METHOD FOR MANUFACTURING THE SAME, AND METHOD FOR HEAT-SENSITIVE TRANSFER RECORDING

(71) Applicant: Toppan Printing Co., Ltd., Tokyo (JP)

(72) Inventors: Akihiko Ito, Tokyo (JP); Kosuke Kinoshita, Tokyo (JP); Yasuhiro Miyauchi, Tokyo (JP); Ken Oshinomi, Tokyo (JP)

(21) Appl. No.: 14/490,512

(22) Filed: Sep. 18, 2014

Related U.S. Application Data
(63) Continuation of application No. PCT/JP2013/058124, filed on Mar. 21, 2013.

(30) Foreign Application Priority Data
Mar. 21, 2012 (JP) 2012-063714
Mar. 22, 2012 (JP) 2012-065485
Mar. 23, 2012 (JP) 2012-067992
Mar. 23, 2012 (JP) 2012-067993

(51) Int. Cl. B41M 5/382

(52) U.S. Cl. CPC B41M 5/38214
USPC 206/393

(57) ABSTRACT

A heat-sensitive transfer recording medium of the invention comprises a supply core about which a heat-sensitive recording sheet is wound, a take-up core to which one end of the heat-sensitive transfer recording medium is fixed for winding up the heat-sensitive transfer recording medium, and a tape fixing the heat-sensitive transfer recording sheet and the take-up core therewith, the tape having a longitudinal elasticity of not larger than about 1.0×10⁷ Pa.

### CROSS-REFERENCE TO RELATED PATENT APPLICATIONS

This application is a continuation of application filed under 35 U.S.C. 111(a) claiming the benefit under 35 U.S.C. §§120 and 365(c) of PCT International Application No. PCT/JP2013/058124 filed on Mar. 21, 2013, which is based upon and claims the benefit of priority of Japanese Application No. 2012-063714 filed on Mar. 21, 2012; Japanese Application No. 2012-065485 filed on Mar. 22, 2012; Japanese Application No. 2012-067992 filed on Mar. 23, 2012; and Japanese Application No. 2012-067993 filed on Mar. 23, 2012, the entire contents of which are hereby incorporated by reference in their entireties.

### BACKGROUND OF THE INVENTION

1. Technical Field

The present invention relates to a heat-sensitive transfer recording medium used for a heat-sensitive transfer type printer, and more particularly, to a heat-sensitive transfer recording medium including a supply core around which a heat-sensitive transfer recording sheet is rolled and a take-up core which rolls up the heat-sensitive transfer recording sheet.

2. Background Art

Heat-sensitive transfer recording media, which are generally used in many cases in the form of ink ribbons in heat-transfer type printers, are also called thermal ribbons. In general, such a heat-sensitive transfer recording medium has a structure that includes a base having one surface provided with a heat-sensitive transfer layer and the other surface provided with a heat-resistant lubricating layer (back coat layer). The heat-sensitive transfer layer is a layer of an ink, and the ink of the layer is transferred to an object to be transferred by sublimation (sublimation transfer method) or melting (melt transfer method) by means of heat generated at a thermal head of a printer.

Of these methods, the sublimation transfer method enables easy full-color formation of various images in combination with a sophisticated printer and thus has been widely used such as for real-time prints of digital cameras, cards such as for identification, or output materials for amusement. As the usage of the heat-sensitive transfer recording media is diversified, there arises an increasing need for the media to reduce size, increase speed, reduce cost or enhance durability of the obtained printed materials. For this reason, predominantly prevailing heat-sensitive transfer recording media of recent years include a plurality of heat-sensitive transfer layers which are provided on one surface of a base sheet so as not to be overlaid such as on a protective layer that imparts durability to the photo prints.

Under such circumstances, as the printing speed of printers is more increasing in association with the diversified and predominantly prevailing usage of heat-sensitive transfer recording media, the driving speed of thermal ribbons is also increased. As a result, a required torque generated such as by a motor is also increasing, thereby leading to an increase of the load imposed such as on a gear in a drive section.

The increase of the torque imposed on a gear in the drive section leads to an increase of driving unevenness that causes gear streaks or the like. Further, the increase in the speed of printing leads to the increase of the energy applied to a thermal head during printing. This raises a problem that the irregularities, which have a given pitch attributed to the driving unevenness but have been undistinguishable at low-speed printing, are unavoidably transferred to photo prints.

In order to solve such a problem, PTL 1, for example, proposes to provide a plurality of take-up bobbin slide parts to a take-up bobbin core to which a take-up bobbin for winding up a printer's ink ribbon is mounted. The take-up bobbin slide parts are provided on the circumference of the take-up bobbin core so as to be movable in a direction perpendicular to the circumference.

### CITATION LIST

### Patent Literatures

Patent Literature 1: JP-A-2009-126122

### SUMMARY OF THE INVENTION

### Technical Problem

However, the structure proposed by PTL 1 is difficult to be actually put into practice because the structure increases the number of parts of the printer and thus increases the costs of the printer.

Thus, with the use of sublimation transfer-type high-speed printers of today, the only practical measure, according to conventional art, against print irregularities having a given pitch attributed to the driving unevenness of the printer is to improve the printer, that is, to slow down the printing speed. Such existing circumstances stand up as a factor of creating difficulty in increasing speed of printing.

The present invention has been made in light of the circumstances set forth above and has as its object to provide a heat-sensitive transfer recording medium which is more unlikely to cause print irregularities during high-speed printing, the print irregularities being attributed to driving unevenness of a drive section of a printer.

### Solution to Problem

[1] A heat-sensitive transfer recording medium related to a first embodiment of the present invention includes: a supply core that rolls a heat-sensitive transfer recording sheet thereabout; a take-up core that fixes an end of the heat-sensitive transfer recording sheet thereto and takes up the heat-sensitive transfer recording sheet; and a tape that fixes the heat-sensitive transfer recording sheet and the take-up core to each other, wherein: the tape has a longitudinal elastic coefficient of not more than about 1.0×10⁷ Pa.

[2] In [1] above, it is preferred that the tape has a thickness of not less than about 0.4 mm but not more than about 1.0 mm.

[3] In [1] above, it is preferred that the tape has a length of not less than about 5 mm in a take-up direction of the tape.

[4] In [1] above, it is preferred that the tape is adhered to the take-up core throughout an axial direction of the take-up core.

[5] In [1] above, it is preferred that the heat-sensitive transfer recording sheet is fixed to an outer peripheral surface of the take-up core via the tape over ½ or more of the outer peripheral surface of the take-up core.

[6] In [5] above, it is preferred that the heat-sensitive transfer recording sheet has a width that is set to be smaller than a dimension of the take-up core along an axial direction.

[7] In [1] above, it is preferred that the heat-sensitive transfer recording medium includes a cushion material attached to an outer peripheral surface of the take-up core.

[8] In [7] above, it is preferred that the heat-sensitive transfer recording sheet has an end attached to the cushion material so that the sheet is fixed to the take-up core.

### Advantageous Effects of the Invention

According to the heat-sensitive transfer recording medium of the present invention, print irregularities attributed to driving unevenness of a drive section of a printer are unlikely to occur during high-speed printing.

### BRIEF DESCRIPTION OF THE DRAWINGS

FIG. 1 is a side cross-sectional view of a heat-sensitive transfer recording medium related to first and second embodiments of the present invention;

FIG. 2 is an enlarged view of a take-up core and a tape in the heat-sensitive transfer recording medium related to the second embodiment of the invention;

FIG. 3 is a side cross-sectional view of a heat-sensitive transfer recording medium related to a third embodiment of the invention;

FIG. 4 is an enlarged perspective view of a take-up core and a tape in the heat-sensitive transfer recording medium related to the third embodiment of the invention;

FIG. 5A is a diagram illustrating a structure in which tapes are attached to a take-up core in each example related to the third embodiment of the invention;

FIG. 5B is a diagram illustrating a structure in which tapes are attached to a take-up core in each example related to the third embodiment of the invention;

FIG. 5C is a diagram illustrating a structure in which tapes are attached to a take-up core in each example related to the third embodiment of the invention;

FIG. 5D is a diagram illustrating a structure in which tapes are attached to a take-up core in each example related to the third embodiment of the invention;

FIG. 5E is a diagram illustrating a structure in which tapes are attached to a take-up core in each example related to the third embodiment of the invention;

FIG. 5F is a diagram illustrating a structure in which tapes are attached to a take-up core in each example related to the third embodiment of the invention;

FIG. 6A is a diagram illustrating a structure in which tapes are attached to a take-up core in each comparative example related to the third embodiment of the invention;

FIG. 6B is a diagram illustrating a structure in which tapes are attached to a take-up core in each comparative example related to the third embodiment of the invention;

FIG. 6C is a diagram illustrating a structure in which tapes are attached to a take-up core in each comparative example related to the third embodiment of the invention;

FIG. 6D is a diagram illustrating a structure in which tapes are attached to a take-up core in each comparative example related to the third embodiment of the invention;

FIG. 6E is a diagram illustrating a structure in which tapes are attached to a take-up core in each comparative example related to the third embodiment of the invention;

FIG. 6F is a diagram illustrating a structure in which tapes are attached to a take-up core in each comparative example related to the third embodiment of the invention;

FIG. 6G is a diagram illustrating a structure in which tapes are attached to a take-up core in each comparative example related to the third embodiment of the invention;

FIG. 7 is a side cross-sectional view of a heat-sensitive transfer recording medium related to a fourth embodiment of the invention;

FIG. 8 is a side cross-sectional view of a modification of the heat-sensitive transfer recording medium related to the fourth embodiment of the invention; and

FIG. 9 is a side cross-sectional view of a modification of the heat-sensitive transfer recording medium related to the fourth embodiment of the invention.

### DETAILED DESCRIPTION OF THE PREFERRED EMBODIMENTS

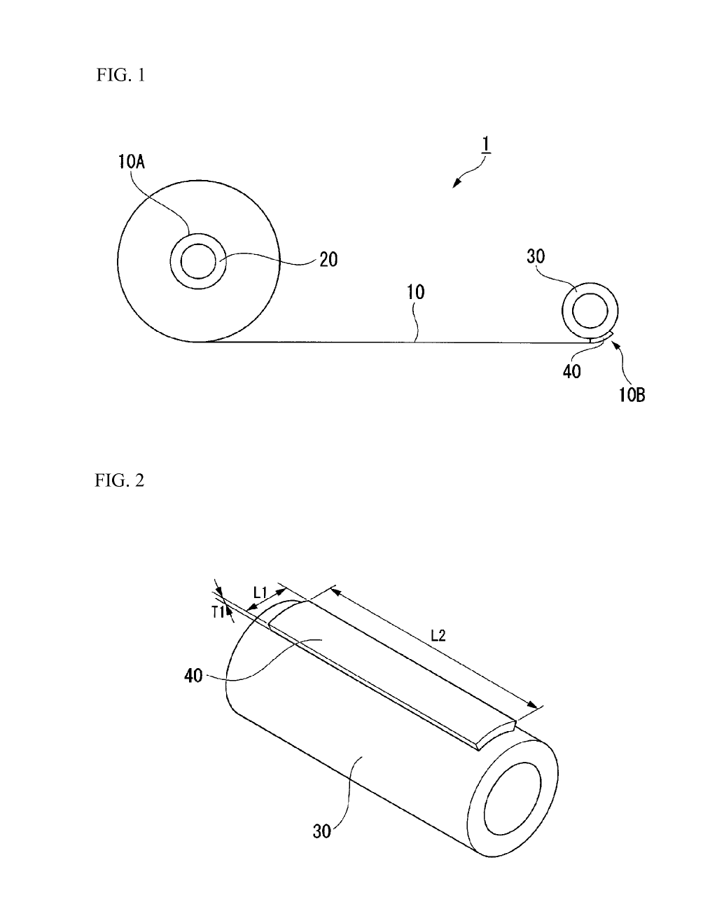

Referring to FIG. 1, a first embodiment of the present invention is described.

A heat-sensitive transfer printing medium 1 related to the first embodiment of the invention includes a supply core 20 around which a heat-sensitive transfer recording sheet 10 is rolled, a take-up core 30 that winds up the heat-sensitive transfer recording sheet 10, and a tape 40 that fixes the heat-sensitive transfer recording sheet 10 to the take-up core 30.

The heat-sensitive transfer recording sheet 10 has a well-known structure that includes a sheet-shaped base, a dye layer formed on one surface of the base, and a heat-resistant lubricating layer formed on the other surface of the base.

The base is required to have a heat resistance and strength so as not to be softened and deformed by application of thermal pressure during thermal transfer. For example, the base used is constituted of: a synthetic resin film such as of polyethylene terephthalate, polyethylene naphthalate, polypropylene, cellophane, acetate, polycarbonate, polysulphone, polyimide, polyvinyl alcohol, aromatic polyamide, aramid or polystylene; or paper, such as condenser paper or paraffin paper. These films or papers can be used singly or in combinations of two or more. Among them, polyethylene terephthalate is preferable, taking into account such factors as the physical properties, processability or cost. When operability or processability is concerned, the heat-sensitive transfer recording sheet has a thickness within a range of not less than 2 μm to not more than 50 μm. Further, when handleability, such as transferability or processability, is concerned, a thickness of about not less than 2 μm but not more than 9 μm is preferred.

For the dye layers, known materials may be used. For example, the dye layer may be formed by formulating a heat-transferable dye, a binder, a solvent and the like to prepare a coating solution for forming a dye layer, coating the coating solution on one surface of the base, followed by drying. It will be noted that the dye layer may also be constituted by a single layer of a single color, or may be formed by successively and repeatedly forming a plurality of dye layers that contain dyes of different color tones on the same surface of a base.

The heat-transferable dye of the dye layer is a dye that is melted, diffused, or sublimated and transferred by heat. For example, a yellow component includes Solvent Yellow 56, 16, 30, 93 or 33, Disperse Yellow 201, 231 or 33, or the like. A magenta component includes C.I. Disperse Red 60, C.I. Disperse Violet 26, C.I. Disperse Violet 38, C.I. Solvent Red 27, or C.I. Solvent Red 19, or the like. Among them, a dye comprised of an anthraquinone compound represented such as by C.I. Disperse Violet 38 should essentially be used. A cyan component includes C.I. Disperse Blue 354, C.I. Solvent Blue 63, C.I. Solvent Blue 36, C.I. Solvent Blue 266, C.I. Disperse Blue 257, C.I. Disperse Blue 24, or the like. Among them, a dye comprised of an anthraquinone compound represented such as by C.I. Solvent Blue 63, C.I. Solvent Blue 36 or C.I. Disperse Blue 24 should essentially be used. This is because, when an underlying layer, which is described later, is introduced between the base and the dye layer, the dye comprised of an anthraquinone compound is more excellent in transfer efficiency to an image-receiving layer than other types of dyes. As a result, high transfer sensitivity can be imparted, i.e. the dye used of the dye layer can be reduced in amount.

The dye layer may appropriately be blended with a binder. Any known resins, not particularly limited, can be used as the binder. For example, the binder includes: a cellulose-base resin, such as ethyl cellulose, hydroxyethyl cellulose, ethyl hydroxy cellulose, hydroxypropyl cellulose, methylcellulose or acetylcellulose; a vinyl-based resin, such as polyvinyl alcohol, polyvinyl acetate, polyvinyl butyral, polyvinyl acetal, polyvinyl pyrrolidone or polyacrylamide; a polyester resin; a styrene-acrylonytrile copolymer resin; or a phenoxy resin.

The formulation ratio of dye and binder in the dye layer on mass basis is preferably at (dye)/(binder)=10/100 to 300/100. This is because, when the ratio of (dye)/(binder) is lower than 10/100, the amount of the dye is too small to ensure sufficient color development sensitivity and thus a good heat transfer image is not obtained, but when the ratio exceeds 300/100, solubility of dye relative to binder extremely lowers. Thus, the resulting heat-sensitive transfer recording medium becomes poor in storage stability, allowing the dye to easily precipitate. The dye layer may contain well-known additives, such as a dispersant, a viscosity modifier and a stabilizer, within ranges of amount not impairing the performance.

As necessary, an underlying layer may be provided between the base and the dye layer. The underlying layer enhances the adhesion between the base and the dye layer. The underlying layer can be formed by coating and drying a coating solution containing a material having properties of enhancing adhesion between the base and the dye layer, e.g. a water-soluble polymer.

The underlying layer or the coating solution for forming the underlying layer may contain various well-known additives, such as ultrafine particles of colloidal inorganic pigments, an isocyanate compound, a silane coupling agent, a dispersant, a viscosity modifier and a stabilizer, within ranges not impeding the adhesion between the base and the dye layer. The ultrafine particles of colloidal inorganic pigments used include well-known particles, such as of silica (colloidal silica), alumina or alumina hydrate (e.g., alumina sol, colloidal alumina, cationic aluminum oxide or its hydrate, or pseudo-boehmite), aluminum silicate, magnesium silicate, magnesium carbonate, magnesium oxide or titanium oxide.

The heat-resistant lubricating layer may be made of well-known materials. For example, the heat-resistant lubricating layer can be formed by formulating a resin that serves as a binder, a functional additive that imparts releasability and lubricity, a filler, a curing agent, a solvent and the like to prepare a coating solution for forming the heat-resistant lubricating layer, followed by coating and drying to form a heat-resistant, lubricating layer. The heat-resistant lubricating layer formed in this way preferably has a dry coating amount of about not less than 0.1 g/m² but not more than 2.0 g/m².

The dry coating amount of the heat-resistant lubricating layer means a solid content left after coating and drying of the coating solution for forming the heat-resistant lubricating layer. This definition is true of the dye layer and the underlying layer.

As an example of the material used as the binder resin in the heat-resistant lubricating layer, mention is made of a polyvinyl butyral resin, polyvinyl acetoacetal resin, polyester resin, vinyl chloride-vinyl acetate copolymer, polyether resin, polybutadiene resin, acryl polyol, polyurethane acrylate, polyester acrylate, polyether acrylate, epoxy acrylate, nitrocellulose resin, cellulose acetate resin, polyamide resin, polyimide resin, polyamide-imide resin, polycarbonate resin or polyacrylic resin, or modified products thereof.

The heat-resistant lubricating layer, the underlying layer and the dye layer can all be formed by coating by use of a well-known coating method and drying. As examples of the coating method, mention is made of gravure coating, screen printing, spray coating or reverse roll coating.

In the base, the surface for forming the heat-resistant lubricating layer or the underlying layer may be subjected to a treatment for enhancing adhesion between the layer formed on the base surface and the base surface (hereinafter referred to as “adhesion imparting treatment”). For the adhesion imparting treatment, there may be applied a well-known technique, such as corona treatment, flame treatment, ozone treatment, ultraviolet treatment, radiation treatment, surface-roughening treatment, plasma treatment or primer treatment. These treatments may be used in combination of two or more.

The supply core 20 and the take-up core 30 are each formed into a pillar or cylindrical shape using a resin or the like. The heat-sensitive transfer recording sheet 10 has an end 10A which is attached to the supply core 20 and wound about the outer peripheral surface of the supply core 20. The structure in which the end 10A is attached to the supply core 20 is not particularly limited. The end 10A may be completely fixed or may be attached to an extent that the end is peeled off by application of a given force.

The heat-sensitive transfer recording sheet 10 has the other end 10B which is fixed to the outer peripheral surface of the take-up core 30 via the tape 40. In the tape 40, the bonded heat-sensitive transfer recording sheet 10 is ensured to have a longitudinal elastic coefficient of not more than about 1.0×10⁷ Pa in a longitudinal direction of the sheet.

The tape 40 is configured by forming an adhesive layer on both surfaces of a sheet-shaped carrier. The longitudinal elastic coefficient of the tape 40 solely depends on the material of the carrier. For example, the material that realizes the longitudinal elastic coefficient of the above range includes, but is not limited to, natural rubber, a synthetic rubber, such as butyl rubber or stylene butadiene rubber, a foam of a synthetic rubber, or a foam of polyethylene or polypropylene. The adhesive layer only has to favorably adhere to both of the take-up core 30 and the heat-sensitive transfer recording sheet 10 and thus a well-known material can be appropriately selected and used.

Since the longitudinal elastic coefficient of the tape 40 is set at not more than about 1.0×10⁷ Pa in the heat-sensitive transfer recording medium 1 related to the first embodiment of the invention, the tape 40 is elastically deformed to favorably absorb wobbling of the heat-sensitive transfer recording sheet 10 in a take-up direction, the wobbling being induced by the driving unevenness of a printer. As a result, the occurrence of print irregularities having a pitch attributed to the driving unevenness can be conveniently suppressed to favorably perform high-speed printing.

Referring to FIGS. 1 and 2, hereinafter is described a second embodiment of the present invention.

A heat-sensitive transfer recording medium 1 related to the second embodiment of the invention has a configuration similar to that of the heat-sensitive transfer recording medium of the first embodiment described above.

A heat-sensitive transfer recording sheet 10 is obtained using a method similar to that described in the first embodiment.

FIG. 2 is an enlarged view of a take-up core and a tape in the heat-sensitive transfer recording medium.

A tape 40 has a length L1 in a take-up direction that is set to not less than 5 mm. Preferably, the length L1 is not less than 10 mm, more preferably not less than 15 mm. A length of not more than 5 mm leads to reduction of the joint area between the heat-sensitive transfer recording sheet 10 and the tape 40 and between the take-up core 30 and the tape 40. As a result, the heat-sensitive transfer recording sheet 10 easily peels off from the tape 40, or the tape 40 easily peels off from the take-up core 30.

The tape 40 has a thickness T1 which is set to a range of from not less than about 0.4 mm to not more than about 1.0 mm. A thickness of less than about 0.4 mm leads to reduction in the effect of mitigating the print irregularities having a pitch attributed to the driving unevenness of the printer. A thickness of more than about 1.0 mm leads to collapse of the wound shape of the heat-sensitive transfer recording sheet 10 relative to the take-up core 3, with the round shape being lost. The take-up speed becomes uneven thereby causing print irregularities having a pitch to occur.

In the present invention, the thickness T1 of the tape 40 refers to a thickness of a carrier.

The tape 40 adhered to the take-up core 30 has a length L2 in an axial direction of the take-up core 30. The length L2 is not particularly limited but may be appropriately set taking account such factors as a width of the heat-sensitive transfer recording sheet 10. The tape 40 is preferably adhered to the take-up core 30 throughout the axial direction of the core 30. This is because the heat-sensitive transfer recording sheet 10 is stably fixed to the take-up core 30.

Since the thickness T1 of the tape 40 is set to a range of from not less than about 0.4 mm to not more than about 1.0 mm in the heat-sensitive transfer recording medium 1 related to the second embodiment of the invention, the wobbling of the heat-sensitive transfer recording sheet 10 in a radial direction attributed to the driving unevenness of the printer is favorably absorbed by the elastic deformation of the tape 40. As a result, the occurrence of print irregularities having a pitch attributed to the driving unevenness is favorably suppressed to favorably perform high-speed printing.

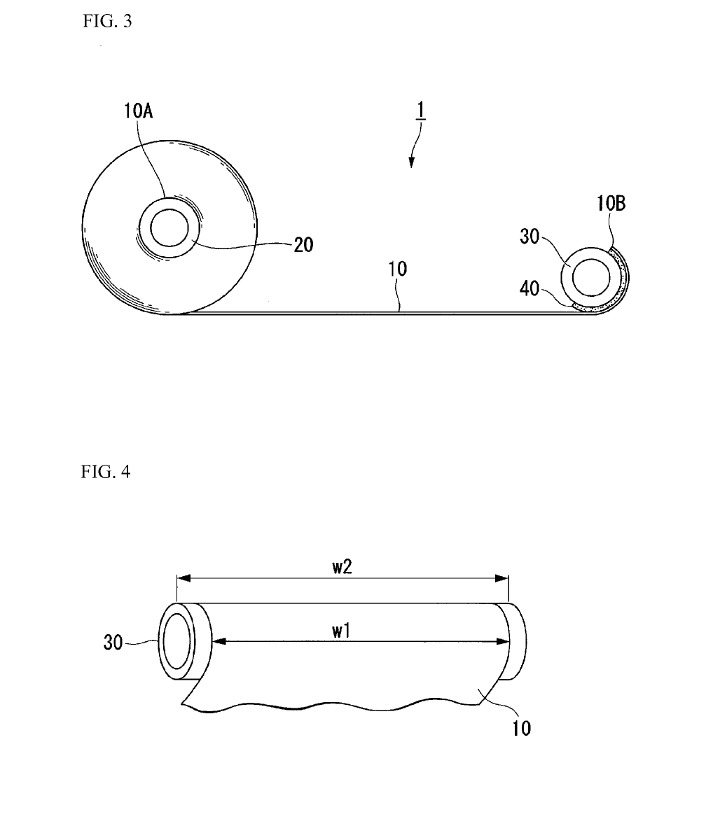

Referring to FIGS. 3 to 6G, a third embodiment of the present invention is now described.

A heat-sensitive transfer recording medium 1 related to the third embodiment of the invention has a configuration similar to that of the heat-sensitive transfer recording medium of the first embodiment.

A heat-sensitive transfer recording sheet 10 is obtained using a method similar to that described in the first embodiment.

A supply core 20 and a take-up core 30 are each formed into a columnar or cylindrical shape using a resin or the like. The heat-sensitive transfer recording sheet 10 has an end 10A which is attached to the supply core 20 and rolled about the outer peripheral surface of the supply core 20. The structure in which the end 10A is attached to the supply core 20 is not particularly limited. The end 10A may be completely fixed to the core or may be attached to the core so as to be peeled off therefrom by application of a given force.

The heat-sensitive transfer recording sheet 10 has the other end 10B which is fixed to the outer peripheral surface of the take-up core 30 via a tape 40. As shown in FIG. 4, the heat-sensitive transfer recording sheet 10 has a width w1 which is set to be smaller than a dimension w2 of the take-up core 30 in an axial direction. Thus, the heat-sensitive transfer recording sheet 10 is unlikely to run off in the axial direction of the take-up core to thereby minimize the occurrence of take-up failure or machine stoppage due to the running off.

The tape 40 is configured by forming an adhesive layer on both surfaces of a sheet-shaped carrier. For example, the material of the carrier includes, but is not limited to, natural rubber, a synthetic rubber, such as butyl rubber or stylene butadiene rubber, a foam of a synthetic rubber, or a foam of polyethylene or polypropylene. The adhesive layer should favorably adhere to both of the take-up core 30 and the heat-sensitive transfer recording sheet 10, for which a well-known material can be appropriately selected and used.

As shown in FIG. 3, the end 10B of the heat-sensitive transfer recording sheet 10 is adhered and fixed to the take-up core 30 via the tape 40 over a length of not less than ½ of the outer periphery of the take-up core 30. Since the heat-sensitive transfer recording sheet 10 is adhered to the take-up core 30 over a length of not less than ½ of the outer periphery of the take-up core 30, the heat-sensitive transfer recording sheet 10 is reliably fixed to the take-up core 30 and thus the heat-sensitive transfer recording sheet is stably rolled up during high-speed printing. As a result, the print irregularities having a pitch attributed to the driving unevenness of the drive section in the printer are improved.

In order to suppress the print irregularities in high-speed printing to a level of practically causing no problem, the length of the heat-sensitive transfer recording sheet 10 fixed with the tape 40 should be not less than about ½ of the outer peripheral length of the take-up core, preferably not less than about ½ but not more than two times the outer peripheral length, more preferably not less than about ½ but not more than one peripheral length. If the fixed length is not less than two times the outer peripheral length, the shape of the heat-sensitive transfer recording sheet being rolled up is collapsed and a round shape may be sometimes lost. In this case, there is concern that the take-up speed becomes uneven thereby leading to print irregularities having a pitch. In addition, fixation of the heat-sensitive transfer recording sheet by not less than one outer peripheral length of the take-up core does not necessarily lead to the improvement in the effect of suppressing print irregularities but with a tendency of only increasing cost.

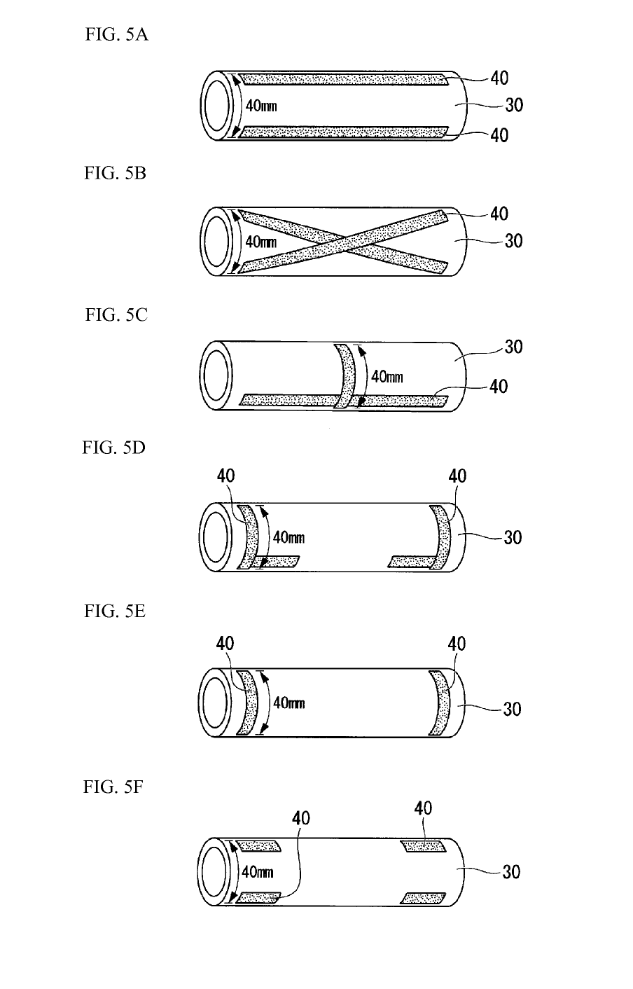

For fixing the heat-sensitive transfer recording sheet 10 about the outer periphery of the take-up core 30 over a length of not less than about ½ thereof, the form of the tape is not particularly limited. Accordingly, the tape 40 may have a form of entirely covering the fixation area. As shown in FIGS. 5A to 5F, the form of the tape may be determined so as to partially cover the fixation area. Further, the form of the tape may be determined so as to partially cover the fixation area by using a structure (method or form) different from the embodiment described above. By ensuring the tape to have a form of partially covering the area to be adhered, the amount of the tape used can be reduced, with a reduction in manufacturing costs.

Referring to FIGS. 7 to 9, a fourth embodiment of the present invention is described.

A heat-sensitive transfer recording medium 1 related to the fourth embodiment of the invention has a configuration similar to that of the heat-sensitive transfer recording medium 1 of the first embodiment.

A heat-sensitive transfer recording sheet 10 is obtained using a method similar to that described in the first embodiment.

A supply core 20 and a take-up core 30 are each formed into a columnar or cylindrical shape using a resin or the like. The heat-sensitive transfer recording sheet 10 has an end 10A which is attached to the supply core 20 and rolled about the outer peripheral surface of the supply core 20. The structure in which the end 10A is attached to the supply core 20 is not particularly limited. The end 10A may be completely fixed to the core or may be attached to the core so as to be peeled off therefrom by application of a given force.

The heat-sensitive transfer recording sheet 10 has the other end 10B which is fixed to the outer peripheral surface of the take-up core 30 via a tape 40. As shown in FIG. 4, the heat-sensitive transfer recording sheet 10 has a width W1 which is set to be smaller than a dimension W2 of the take-up core 30 in an axial direction.

The adhesive layer should favorably adhere to both of the take-up core 30 and the heat-sensitive transfer recording sheet 10 and thus a well-known material can be appropriately be selected and used. The tape 40 may be made of a material similar to a cushion material 50 described later.

The take-up core 30 has an outer peripheral surface which is provided with a cushion material 50 at a position where the tape 40 is not attached. The cushion material 50 is configured by forming an adhesive layer for adhesion to the take-up core 30 on one surface of a sheet-shaped carrier having a cushioning property. For example, the material of the carrier includes, but is not limited to, natural rubber, or a synthetic rubber, such as butyl rubber or stylene butadiene rubber, a foam of a synthetic rubber, or a foam of polyethylene or polypropylene.

The adhesive layer should favorably adhere to the take-up core 30, for which a well-known material can be appropriately selected and used. Alternatively, it may be so configured that the adhesive layer is provided on both surfaces of the carrier and the rolled up heat-sensitive transfer recording sheet 10 is adhered to the cushion material 50. Alternatively, when the adhesive layer is provided on both sides of the cushion material 50, the heat-sensitive transfer recording sheet 10 may be attached to the take-up core 30 via the cushion material 50 without using the tape 40.

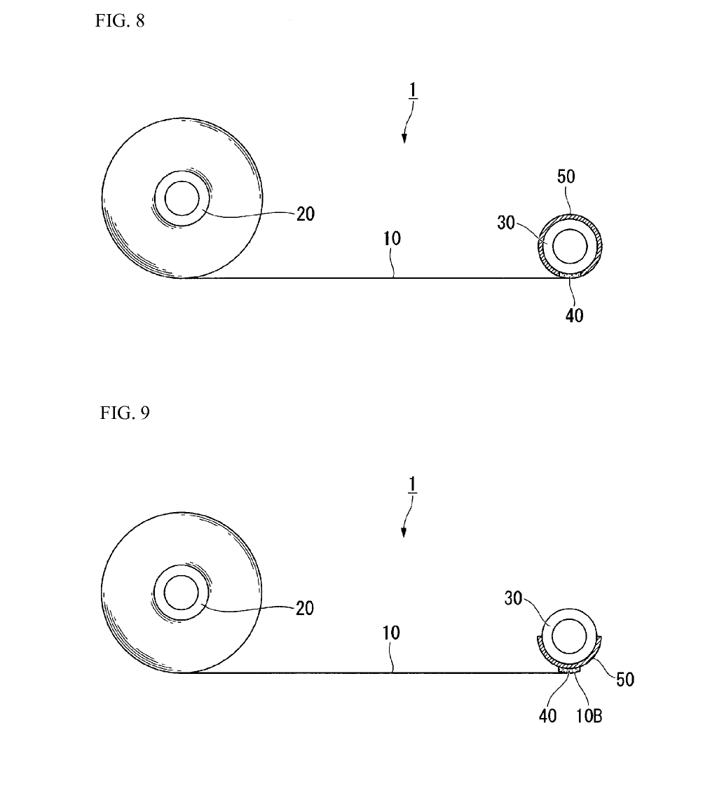

When the area of the cushion material 50 is set to 1/10 or more of the outer peripheral length of the take-up core 30, the print irregularities attributed to the driving unevenness of the drive section in the printer can be suppressed. The area has no upper limit in particular and the cushion material 50 may cover the entire outer peripheral surface of the take-up core 30. When the area is set to the above range, the cushion material is not particularly limited to have a specific form. For example, as shown in FIG. 8, the cushion material may be provided covering the take-up core 30 over its circumferential direction. Alternatively, two or more cushion materials 50 may be provided as being mutually spaced apart in the circumferential direction. Still alternatively, as shown in FIG. 9, a part of the cushion material 50 may be located between the tape 40 and the take-up core 30 so that the end 10B of the heat-sensitive transfer recording sheet 10 is attached to the cushion material. With this configuration, the cushion material directly acts on the end of the heat-sensitive transfer recording sheet 10, so that the effect of the cushion material is more likely to obtain.

Besides, the cushion material 50 may be set over the axial direction of the take-up core 30. Alternatively, two or more cushion materials may be provided as being mutually spaced apart in the axial direction.

According to the heat-sensitive transfer recording medium 1 related to the fourth embodiment of the invention, the elastic deformation of the cushion material 50 that contacts the heat-sensitive transfer recording sheet 10 favorably absorbs the wobbling of the heat-sensitive transfer recording sheet 10 in a radial direction of the take-up core 30, the wobbling being attributed to the driving unevenness of the printer. Thus, in high-speed printing as well, the print irregularities having a pitch attributed to the driving unevenness can be conveniently suppressed.

### EXAMPLES

The heat-sensitive transfer recording media related to the first to fourth embodiments of the invention are more specifically described by way of examples. In the following description, the term “parts” is by mass unless otherwise specified. Further, the heat-sensitive transfer recording media related to the invention are not limited to the following examples.

### (Matters Common to Examples and Comparative Examples)

### <Preparation of a Base of a Heat-Resistant Lubricating Layer>

A base used was a polyethylene terephthalate film having a thickness of 4.5 μm and having one surface subjected to adhesion-imparting treatment. A surface not subjected to the adhesion-imparting treatment was coated with a coating solution for heat-resistant lubricating layer having the following composition by gravure coating in a dry coating amount of 0.5 g/m² and dried at 100° C. for one minute, thereby obtaining a base having a heat-resistant lubricating layer.

### <Heat-Resistant Lubricating Layer Coating Solution>

| | |
|---|---|
| Silicon acrylate (US-350 of Toagosei Co., Ltd.) | 50.0 mass |
| Methyl ethyl ketone | 50.0 mass |

### <Preparation of Heat-Sensitive Transfer Recording Sheet>

An underlying layer coating solution having the following composition was applied by gravure coating onto a surface that had been treated so as to allow easy adhesion of the base having a heat-resistant lubricating layer in such a way that a dry coating amount was 0.20 g/m², followed by drying at 100° C. for two minutes, thereby forming a underlying layer. Further, a dye layer coating solution having the following composition was applied by gravure coating onto the underlying layer so that a dry coating amount was 0.70 g/m², followed by drying at 90° C. for one minute, thereby forming a dye layer. Thus, a heat-sensitive transfer recording sheet was obtained.

### <Underlying Layer Coating Solution>

| | |
|---|---|
| Polyvinyl alcohol | 5.0 mass |
| Pure water | 57.0 mass |
| Isopropyl alcohol | 38.0 mass |

### <Dye Layer Coating Solution>

| | |
|---|---|
| C.I. Solvent Blue 63 | 6.0 mass |
| Polyvinyl acetal resin | 4.0 mass |
| Toluene | 45.0 mass |
| Methyl ethyl ketone | 45.0 mass |

### Example 1

The heat-sensitive transfer recording sheet obtained by the above process was formed into a tape of 160 mm in width. Then, using thermal compression bonding, an end of the tape was fixed to an ABS resin supply core having a diameter of one inch (2.54 cm) and an axial dimension of 170 mm to roll the tape about the core by 200 m. Then, the other end of the heat-sensitive transfer recording sheet was fixed to a take-up core made of the same material and having the same dimensions as the supply core via a double-stick tape (material of the carrier: foamed rubber) of 10 mm×160 mm having a longitudinal elastic coefficient of 1.0×10⁷ Pa, thereby preparing a heat-sensitive transfer recording medium.

### Example 2

A procedure similar to that described in Example 1 was used except that the other end of the heat-sensitive transfer recording sheet was fixed to the take-up core via a double-stick tape (material of the carrier: foamed rubber) of 10 mm×160 mm having a longitudinal elastic coefficient of 5.0×10⁶ Pa.

### Example 3

A procedure similar to that described in Example 1 was used except that the other end of the heat-sensitive transfer recording sheet was fixed to the take-up core using a double-stick tape (material of the carrier: foamed rubber) of 10 mm×160 mm having a longitudinal elastic coefficient of 1.0×10⁶ Pa.

### Comparative Example 1

A procedure similar to that described in Example 1 was used except that the other end of the heat-sensitive transfer recording sheet was fixed to the take-up core via a double-stick tape (material of the carrier: foamed rubber) of 10 mm×160 mm having a longitudinal elastic coefficient of 1.5×10⁷ Pa.

### Comparative Example 2

A procedure similar to that described in Example 1 was used except that the other end of the heat-sensitive transfer recording sheet was fixed to the take-up core via a double-stick tape (material of the carrier: foamed rubber) of 10 mm×160 mm having a longitudinal elastic coefficient of 3.0×10⁷ Pa.

### <Preparation of Transfer Object>

The following procedure was used to prepare a transfer object used for examining print irregularities described later.

A white foamed polyethylene terephthalate film of 188 μm in thickness was used as a base. An image-receiving layer coating solution having the following composition was applied to one surface of the base by gravure coating so as to have a dry coating amount of 5.0 g/m², followed by drying, thereby preparing a transfer object for heat-sensitive transfer.

### <Image-Receiving Layer Coating Solution>

| | |
|---|---|
| Vinyl chloride-vinyl acetate-vinyl | 19.5 mass |
| alcohol copolymer | |
| Amino-modified silicone oil | 0.5 mass |
| Toluene | 40.0 mass |
| Methyl ethyl ketone | 40.0 mass |

### <Evaluation on Printing>

The heat-sensitive transfer recording media of Examples 1-3 and Comparative Examples 1 and 2 were used. A thermal printer for evaluation was used by setting a monochrome printing speed to 3.0 inches (7.62 cm)/sec to successively print 10 screen images using the heat-sensitive transfer recording sheet. Then, organoleptic evaluation was conducted of print irregularities having a pitch in black solid printing.

### <Print Irregularities Having a Pitch>

Print irregularities having a pitch were evaluated according to the following five-grade standards. Those heat-sensitive transfer recording sheets which were evaluated as E, VG and G are judged to have no practical problem.

E (EXCELLENT): No print irregularities having a pitch were observed in the transfer object.

VG (VERY GOOD): Print irregularities having a pitch were observed in the transfer object only in reflected light.

G (GOOD): Print irregularities having a pitch are observed only slightly in the transfer object.

P (POOR): Clear print irregularities having a pitch were partially observed in the transfer object.

VP (VERY POOR): Clear print irregularities having a pitch were observed over the entire surface of the transfer object.

The results are shown in Table 1.

TABLE 1

| | Longitudinal elastic | Evaluation on print |
|---|---|---|
| | coefficient | irregularities |
| Example 1 | 1.0 × 10⁷ Pa | E |
| Example 2 | 5.0 × 10⁶ Pa | VG |
| Example 3 | 1.0 × 10⁶ Pa | G |
| Comparative Example 1 | 1.5 × 10⁷ Pa | P |
| Comparative Example 2 | 3.0 × 10⁷ Pa | VP |

As shown in Table 1, print irregularities having a pitch tended to be improved as the longitudinal elastic coefficient of a tape lowered. It was revealed that, when the take-up core and a heat-sensitive transfer recording sheet were fixed with a tape having a longitudinal elastic coefficient of not more than 1.0×10⁷ Pa, driving unevenness in the printer was alleviated and the print irregularities having a pitch could be improved to a practical level.

The heat-sensitive transfer recording medium related to a second embodiment of the invention is more specifically described by way of examples. In the following description, the term “parts” is by mass unless otherwise specified. Further, the heat-sensitive transfer recording medium related to the present invention is not limited to the following examples.

A heat-sensitive transfer recording sheet was obtained using a method similar to that described in Example 1.

### Example 4

The heat-sensitive transfer recording sheet obtained by the above process was formed into a tape of 160 mm in width. Then, using thermal compression bonding, an end of the tape was fixed to a supply core made of an ABS resin and having a diameter of 1 inch (2.54 cm) and an axial dimension of 170 mm to roll the tape about the core by 200 m. Then, the other end of the heat-sensitive transfer recording sheet was fixed to a take-up core made of the same material and having the same dimensions as the supply core via a double-stick tape having the length L1 of 5 mm, the length L2 of 160 mm and the thickness T1 of 0.4 mm, thereby preparing a heat-sensitive transfer recording medium.

### Example 5

A procedure similar to that described in Example 4 was used except that the other end of the heat-sensitive transfer recording sheet was fixed to the take-up core via a double-stick tape having the length L1 of 5 mm, the length L2 of 160 mm and the thickness T1 of 1.0 mm.

### Example 6

A procedure similar to that described in Example 4 was used except that the other end of the heat-sensitive transfer recording sheet was fixed to the take-up core using a double-stick tape having the length L1 of 10 mm, the length L2 of 160 mm and the thickness T1 of 0.4 mm.

### Example 7

A procedure similar to that described in Example 4 was used except that the other end of the heat-sensitive transfer recording sheet was fixed to the take-up core via a double-stick tape having the length L1 of 10 mm, the length L2 of 160 mm and the thickness T1 of 1.0 mm.

### Example 8

A procedure similar to that described in Example 4 was used except that the other end of the heat-sensitive transfer recording sheet was fixed to the take-up core via a double-stick tape having the length L1 of 15 mm, the length L2 of 160 mm and the thickness T1 of 0.4 mm.

### Example 9

A procedure similar to that described in Example 4 was used except that the other end of the heat-sensitive transfer recording sheet was fixed to the take-up core via a double-stick tape having the length L1 of 15 mm, the length L2 of 160 mm and the thickness T1 of 1.0 mm.

### Comparative Example 3

A procedure similar to that described in Example 4 was used except that the other end of the heat-sensitive transfer recording sheet was fixed to the take-up core via a double-stick tape having the length L1 of 3 mm, the length L2 of 160 mm and the thickness T1 of 1.0 mm.

### Comparative Example 4

A heat-sensitive transfer recording medium was prepared through the same procedure as in Example 4 except that the other end of the heat-sensitive transfer recording sheet was fixed to the take-up core via a double-stick tape having the length L1 of 15 mm, the length L2 of 160 mm and the thickness T1 of 2.0 mm.

### <Preparation of Transfer Object>

A transfer object used for examining print irregularities described later was prepared through a procedure similar to that described in Example 1.

### <Printing Evaluation>

The heat-sensitive transfer recording media of Examples 4-9 and Comparative Examples 3 and 4 were used. A thermal printer for evaluation was used by setting monochrome printing speed to 3.0 inches (7.62 cm)/sec to perform printing until the heat-sensitive transfer recording sheet was used up. Then, organoleptic evaluation was conducted of print irregularities having a pitch in black solid printing.

### <Print Irregularities Having a Pitch>

Print irregularities having a pitch were evaluated according to two-grade standards.

G (GOOD): No print irregularities having a pitch are observed in the transfer object.

P (POOR): Clear print irregularities having a pitch are observed over the entire surface.

The results are shown in Table 2.

TABLE 2

| | Length of tape in take- | Thickness of | Evaluation on print |
|---|---|---|---|
| | up direction | tape | irregularities |
| Example 4 | 5 mm | 0.4 mm | G |
| Example 5 | 5 mm | 1.0 mm | G |
| Example 6 | 10 mm | 0.4 mm | G |
| Example 7 | 10 mm | 1.0 mm | G |
| Example 8 | 15 mm | 0.4 mm | G |
| Example 9 | 15 mm | 1.0 mm | G |
| Comparative | 3 mm | 1.0 mm | Impossible to print |
| Example 3 | | | |
| Comparative | 15 mm | 2.0 mm | P |
| Example 4 | | | |

In Examples 4-9 in which the tapes had the thickness T1 that was set in the range of not less than 0.4 mm to not more than 1.0, the print irregularities having a pitch was suppressed to thereby enable high-speed printing.

On the other hand, in Comparative Example 3 in which the length L1 was less than 5 mm, the tape peeled off from the take-up core when a first sheet was printed and thus printing could not be carried out. This was considered to be ascribed to the smallness of the adhesion area between the heat-sensitive transfer recording sheet and the tape and between the take-up core and the tape. In Comparative Example 4 in which the thickness T1 was more than 1.0 mm, print irregularities having a pitch occurred over the entire surface. The occurrence of the print irregularities was considered for the following reasons: the wound-up shape of the heat-sensitive transfer printing sheet relative to the take-up core was collapsed into an elliptic shape and thus, the take-up speed became uneven.

The heat-sensitive transfer recording medium related to a third embodiment of the present invention is more specifically described by way of examples. In the following description, the term “parts” is by mass unless otherwise specified. Further, the heat-sensitive transfer recording medium related to the present invention is not limited to the following examples.

A heat-sensitive transfer recording sheet was obtained by a procedure similar to that described in Example 1.

### Example 10

The heat-sensitive transfer recording sheet obtained through the above process was formed into a tape of 160 mm in width. Then, using thermal compression bonding, an end of the tape was fixed to a supply core made of an ABS resin and having a diameter of 1 inch (2.54 cm) and an axial dimension of 170 mm to roll the tape about the core by 200 m. Then, the other end of the heat-sensitive transfer recording sheet was fixed to a take-up core made of the same material and having the same dimensions as the supply core via a double-stick tape of 160 mm×79.6 mm so as to cover the entire outer periphery of the core (by one circuit), thereby preparing a heat-sensitive transfer recording medium.

### Example 11

A procedure similar to that described in Example 10 was used except that a double-stick tape of 10 mm×200 mm was spirally wound twice on the entire outer periphery of the take-up core.

### Example 12

A procedure similar to that described in Example 10 was used except that a double-stick tape of 160 mm×40 mm was used.

### Example 13

A procedure similar to that described in Example 12 was used except that two double-stick tapes 40 of 160 mm×10 mm were used and attached to the take-up core 30 so that they were parallelly spaced apart from each other as show in FIG. 5A, under which an end of the heat-sensitive transfer recording sheet was fixed over a length of 40 mm.

### Example 14

A procedure similar to that described in Example 12 was used except that an end of the heat-sensitive transfer recording sheet over a length of 40 mm was fixed to the take-up core 30 via two double-stick tapes 40 of 165 mm×10 mm that were attached to the core so as to be crossed each other as shown in FIG. 5B.

### Example 15

A procedure similar to that described in Example 12 was used except that two tapes in total including a double-stick tapes of 160 mm×10 mm and a double-stick tape of 10 mm×40 mm were used and attached to the take-up core 30 so as to be crossed each other as shown in FIG. 5C.

### Example 16

A procedure similar to that described in Example 12 was used except that four tapes 40 in total including two double-stick tapes of 10 mm×40 mm and two double-stick tapes of 40 mm×10 mm were used and attached to the take-up core 30 as shown in FIG. 5D.

### Example 17

A procedure similar to that described in Example 12 was used except that two double-stick tapes 40 of 10 mm×40 mm were attached to the take-up core 30 as shown in FIG. 5E.

### Example 18

A procedure similar to that described in Example 12 was used except that four double-stick tapes 40 of 40 mm×10 mm were used and attached to the core as shown in FIG. 5F thereby fixing an end of the heat-sensitive transfer recording sheet over a length of 40 mm.

### Comparative Example 5

A procedure as in Example 10 was carried out using a double-stick tape 40 of 160 mm×30 mm.

### Comparative Example 6

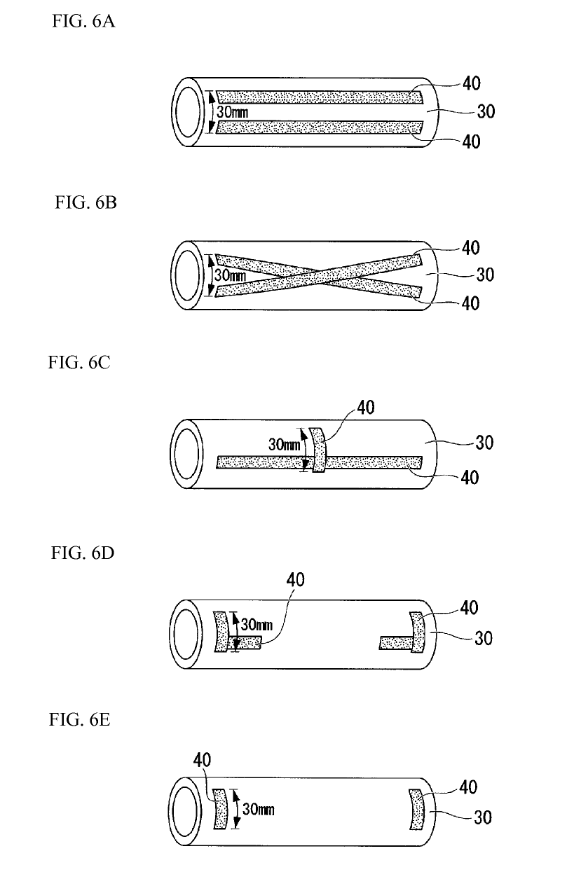

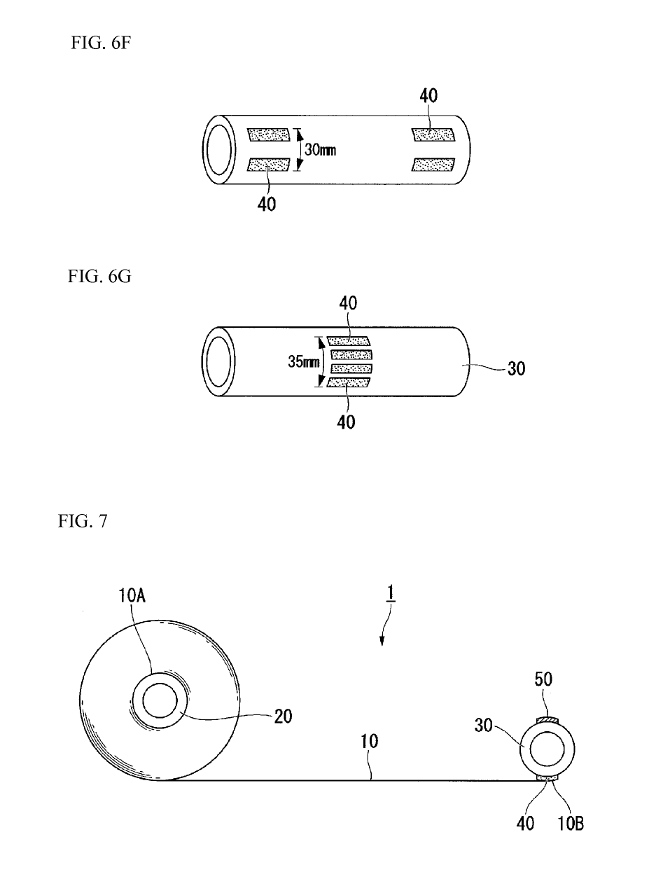

A procedure as in Comparative Example 5 was carried out except that two double-stick tapes 40 of 160 mm×10 mm were used and attached to the take-up core 30 so that they were parallelly spaced apart from each other as show in FIG. 6A, under which an end of the heat-sensitive transfer recording sheet was fixed over a length of 40 mm.

### Comparative Example 7

A procedure similar to that described in Comparative Example 5 was used except that two double-stick tapes 40 of 160 mm×10 mm were used and attached to the take-up core 30 so as to be crossed each other as shown in FIG. 6B, under which an end of the heat-sensitive transfer recording sheet was fixed over a length of 30 mm.

### Comparative Example 8

A procedure similar to that described in Comparative Example 5 was used except that two double-stick tapes 40 in total including a double-stick tape of 160 mm×10 mm and a double-stick tape of 10 m×30 mm were attached to the take-up core 30 so as to be crossed each other as shown in FIG. 6C.

### Comparative Example 9

A procedure similar to that described in Comparative Example 5 was used except that four double-stick tapes 40 in total including two double-stick tapes of 10 mm×30 mm and two double-stick tapes of 40 mm×10 mm were attached to the take-up core 30 as shown in FIG. 6D.

### Comparative Example 10

A procedure similar to that described in Comparative Example 5 was used except that two double-stick tapes 40 of 10 mm×30 mm were used and attached to the take-up core 30 as shown in FIG. 6E.

### Comparative Example 11

A procedure similar to that described in Comparative Example 5 was used except that four double-stick tapes 40 of 10 mm×30 mm were used and attached to the take-up core 30 as shown in FIG. 6E, under which an end of the heat-sensitive transfer recording sheet was fixed over 30 mm.

### Comparative Example 12

A procedure similar to that described in Comparative Example 5 was used except that four double-stick tapes 40 of 10 mm×30 mm were used and attached to the take-up core 30 so as to be circumferentially juxtaposed as shown in FIG. 6G, under which an end of the heat-sensitive transfer recording sheet was fixed over 30 mm.

### <Preparation of Transfer Object>

A transfer object used for checking print irregularities described later was prepared in the same manner as in Example 1.

### <Evaluation on Printing>

The heat-sensitive transfer recording media of Examples 10-18 and Comparative Examples 5-12 were used. A thermal printer for evaluation was used by setting a monochrome printing speed to 3.0 inches (7.62 cm)/sec. Printing was performed until the heat-sensitive transfer recording sheet was used up and then organoleptic evaluation was conducted of print irregularities having a pitch in black solid printing.

### <Print Irregularities Having a Pitch>

Print irregularities having a pitch were evaluated according to five-grade standards. Those heat-sensitive transfer recording sheets which were evaluated as E, VG and G are judged to have no practical problem.

E (EXCELLENT): No print irregularities having a pitch were observed in the transfer object.

VG (VERY GOOD): Print irregularities having a pitch were observed in the transfer object only in reflected light.

G (GOOD): Print irregularities having a pitch were observed only slightly in the transfer object.

P (POOR): Clear print irregularities having a pitch were partially observed in the transfer object.

VP (VERY POOR): Clear print irregularities having a pitch were observed on the entire surface of the transfer object.

The results are shown in Table 3.

TABLE 3

| | Evaluation on print irregularities |
|---|---|
| Example 10 | E |
| Example 11 | VG |
| Example 12 | VG |
| Example 13 | VG |
| Example 14 | VG |
| Example 15 | G |
| Example 16 | G |
| Example 17 | G |
| Example 18 | G |
| Comparative Example 5 | P |
| Comparative Example 6 | P |
| Comparative Example 7 | P |
| Comparative Example 8 | P |
| Comparative Example 9 | P |
| Comparative Example 10 | P |
| Comparative Example 11 | P |
| Comparative Example 12 | VP |

As shown in Table 3, in high-speed printing, print irregularities having a pitch attributed to the driving unevenness in the printer were suppressed to a level having practically no problem in the heat-sensitive transfer printing media of Examples 10-18 in which the heat-sensitive transfer recording sheet was adhered and fixed to the take-up core covering one half the circumference or more of the core.

Further, print irregularities were favorably suppressed in these examples by fixing the heat-sensitive transfer recording sheet by about a full length of the outer periphery.

On the other hand, print irregularities having a pitch were not well suppressed in high-speed printing with respect to the heat-sensitive transfer printing media of Comparative Examples 5-12 in which the heat-sensitive transfer printing sheet was adhered and fixed to the take-up core over less than one half the periphery of the core.

The heat-sensitive transfer recording medium related to a fourth embodiment of the present invention is more specifically described by way of examples. In the following description, the term “parts” is by mass unless otherwise specified. Further, the heat-sensitive transfer recording medium related to the present invention is not limited to the following examples.

A heat-sensitive transfer recording sheet was obtained in the same manner as in Example 1.

### Example 19

The heat-sensitive transfer recording sheet obtained by the above procedure was formed into a tape of 160 mm in width. Then, using thermal compression bonding, an end of the tape was fixed to a supply core made of an ABS resin and having a diameter of 1 inch (2.54 cm) and an axial dimension of 170 mm to roll the tape about the core by 200 m. Then, the other end of the heat-sensitive transfer recording sheet was fixed to a take-up core made of the same material and dimensions as the supply core via a double-stick tape of 160 mm×10 mm. Further, a cushion material (material of the carrier: foamed rubber) of 160 mm×8.47 mm (area corresponding to 10% of the outer peripheral area of the take-up core) having a thickness of 0.4 mm was attached to the outer peripheral surface of the take-up core, thereby preparing a heat-sensitive transfer recording medium.

### Example 20

A procedure similar to that described in Example 19 was used except that two cushion materials indicated above were attached to the outer peripheral surface of the take-up core.

### Example 21

A procedure similar to that described in Example 19 was carried out using a cushion material of 160 mm×21.18 mm (with an area corresponding to 25% of the outer peripheral area of the take-up core).

### Example 22

A procedure similar to that described in Example 21 was carried out using a cushion material of 160 mm×41.37 mm (with an area corresponding to 50% of the outer peripheral area of the take-up core).

### Example 23

A procedure similar to that described in Example 19 was carried out except that an end of the heat-sensitive transfer recording sheet was attached to the cushion material via a double-stick tape.

### Example 24

A procedure similar to that described in Example 20 was carried out except that an end of the heat-sensitive transfer recording sheet was attached to the cushion materials via a double-stick tape.

### Example 25

A procedure similar to that described in Example 21 was carried out except that an end of the heat-sensitive transfer recording sheet was attached to the cushion material via a double-stick tape.

### Example 26

A procedure similar to that described in Example 22 was used except that an end of the heat-sensitive transfer recording sheet was attached to the cushion material via a double-stick tape.

### Example 27

A procedure similar to that described in Example 19 was used except that the entire outer peripheral surface of the take-up core excepting the area where a double-stick tape was attached was covered with a cushion material.

### Example 28

A procedure similar to that described in Example 19 was used except that a cushion material was attached to the take-up core so as to cover the entire outer peripheral surface of the core and an end of the heat-sensitive transfer recording sheet was attached to the cushion material via a double-stick tape.

### Comparative Example 13

A procedure similar to that described in Example 19 was used except that no cushion material was attached to the take-up core.

### <Preparation of Transfer Object>

A transfer object used for checking print irregularities described later was prepared in the same manner as in Example 1.

### <Evaluation on Printing>

The heat-sensitive transfer recording media of Examples 19-28 and Comparative Example 13 were used. A thermal printer for evaluation was used by setting monochrome printing speed to 3.0 inches (7.62 cm)/sec to successively print 10 screen images for each heat-sensitive transfer recording sheet. Then, organoleptic evaluation was conducted of print irregularities having a pitch in black solid printing.

### <Print Irregularities Having a Pitch>

Print irregularities having a pitch were evaluated on two-grade standards. Those heat-sensitive transfer recording sheets which were evaluated with G are judged to have no practical problem.

G (GOOD): No print irregularities having a pitch were observed in the transfer object.

P (POOR): Clear print irregularities having a pitch were observed in the entire surface of the transfer object.

The results are shown in Table 4.

TABLE 4

| | Evaluation on print irregularities |
|---|---|
| Example 19 | G |
| Example 20 | G |
| Example 21 | G |
| Example 22 | G |
| Example 23 | G |
| Example 24 | G |
| Example 25 | G |
| Example 26 | G |
| Example 27 | G |
| Example 28 | G |
| Comparative Example 13 | P |

As shown in Table 4, print irregularities having a pitch attributed to the driving unevenness of the printer were favorably suppressed in high-speed printing for the heat-sensitive transfer recording media of Examples 19-28, in which a cushion material was attached to the outer peripheral surface of the take-up core.

In contrast, print irregularities having a pitch were not well suppressed in high-speed printing for the heat-sensitive transfer medium of Comparative Example 13, in which no cushion material was attached to the outer peripheral surface of the take-up core.

The heat-sensitive transfer recording medium obtained in the present invention can be used in a sublimation transfer-type printer and easily enables full-color formation of various images in combination with a high-speed and sophisticated printer. Thus, the heat-sensitive transfer recording medium obtained in the present invention can be widely used such as for real-time prints of digital cameras, cards such as for identification, or output materials for amusement.

An embodiment and examples of the present invention has so far been described. However, the technical scope of the invention should not be construed as being limited to the foregoing embodiment. The constituent elements of the invention may be variously modified or omitted within a scope not departing from the spirit of the invention.

For example, in the foregoing embodiment and examples, the tape used is a double-stick tape having an adhesive layer on both sides. Alternative to this, a tape having an adhesive layer on one side alone may be used.

In this case, the tape is fixed to the take-up core so that the tape can cover an end of the heat-sensitive transfer recording sheet. When the heat-sensitive transfer recording sheet is rolled about the take-up core by one cycle or more, the tape is interposed between the heat-sensitive transfer recording sheet and the take-up core and shows the effect of suppressing print irregularities.

Instead, the heat-sensitive transfer recording sheet may be bonded to the adhesive-layer-free surface of the tape, by using an adhesive layer or thermal compression bonding. In this case as well, the heat-sensitive thermal recording sheet can be fixed to the take-up core via the tape. This method is particularly preferable when the outer peripheral surface of the take-up core is covered with the tape throughout the circumferential direction.

### REFERENCE NUMBERS LIST

1 Heat-sensitive transfer recording medium
10 Heat-sensitive transfer recording sheet
20 Supply core
30 Take-up core
40 Tape
50 Cushion material

What is claimed is:

1. A heat-sensitive transfer recording medium comprising:
a supply core about which a heat-sensitive transfer recording sheet is rolled;
a take-up core that fixes an end of the heat-sensitive transfer recording sheet thereto and rolls up the heat-sensitive transfer recording sheet; and
a tape that fixes the heat-sensitive transfer recording sheet and the take-up core to each other,
wherein the tape has a longitudinal elastic coefficient of not more than about 1.0×10⁷ Pa.

2. The heat-sensitive transfer recording medium of claim 1, wherein the tape has a thickness of not less than about 0.4 mm to not more than about 1.0 mm.

3. The heat-sensitive transfer recording medium of claim 1, wherein the tape has a length of not less than about 5 mm in a take-up direction of the tape.

4. The heat-sensitive transfer recording medium of claim 1, wherein the tape is adhered to the take-up core throughout an axial direction of the take-up core.

5. The heat-sensitive transfer recording medium of claim 1, wherein the heat-sensitive transfer recording sheet is fixed to an outer peripheral surface of the take-up core via the tape over a length of about ½ or more of the outer peripheral surface of the take-up core.

6. The heat-sensitive transfer recording medium of claim 5, wherein the heat-sensitive transfer recording sheet has a width that is set to be smaller than a dimension of the take-up core in an axial direction.

7. The heat-sensitive transfer recording medium of claim 1, wherein the medium comprises a cushion material attached to an outer peripheral surface of the take-up core.

8. The heat-sensitive transfer recording medium of claim 7, wherein an end of the heat-sensitive transfer recording sheet is attached to the cushion material so that the sheet is fixed to the take-up core.
